(19) United States
(12) Patent Application Publication
(10) Pub. No.: US 2011/0188250 A1
(43) Pub. Date: Aug. 4, 2011

(54) Lighted Decorative Framework

(76) Inventors: Svetlana Waldhuetter, Green Bay, WI (US); Kurt Raymond Waldhuetter, Green Bay, WI (US)

(21) Appl. No.: 13/017,715

(22) Filed: Jan. 31, 2011

Related U.S. Application Data
(60) Provisional application No. 61/337,119, filed on Feb. 1, 2010.

(51) Int. Cl. F21S 4/00

(52) U.S. Cl. 362/249.05; 362/249.01

(57) ABSTRACT

A lighting structure configured to provide lighting into a room is disclosed. The structure is adapted to provide lighting directed to the center of the room, the ceiling, the sides and the floor. The lighting directed to the center of the room is configured to exit into the room though apertures having decorative shapes. The structure comprises a front chamber assembly containing a plurality of solid state strip lights that emit light through the apertures disposed in an insert panel contained within a frame adapted to attach to the front of the chamber assembly. Additional lighting may be placed in the interior of the structure and the top panel of the structure that provide lighting to the floor and ceiling. Additional chamber assemblies may be installed on the top, sides and bottom of the light structure.

### RELATED APPLICATIONS

This application claims priority from provisional application No. 61/337119 filed on Feb. 1, 2010.

### FIELD OF THE INVENTION

The present invention relates to a lighting structure designed to provide lighting to a room through apertures having various artistic shapes using light sources of varying intensities, colors, and directions. The lighting structure is particularly suited for providing indirect or diffuse lighting in bedrooms, dining rooms in residential homes, vacation properties, assisted living homes, nursing homes, hospices, hotels, and restaurants.

### BACKGROUND OF THE INVENTION

Several embodiments for providing decorative lights have been described in prior art references. Some of these embodiments include valance boards and panels, cornices and apertures in combination with window frames, trimmings and panes.

U.S. Pat. No. 5,575,098 discloses an illuminated display apparatus that includes embossed or quilted indicia artistic and pleasing to small children applied to a generally flat surface that is provided with a plurality of apertures disposed at locations relating to the indicia placed thereon and includes illumination devices extending through the plurality of apertures. A solid state switching device applies electrical power to the illumination devices to energize them. Electrical conductors interconnect the source of electrical energy, the switching device, and the illumination devices, all of which are embedded in a soft sponge-like material sandwiched between a backing material cooperating with the flat surface, sandwiching the electrical components there between. The illumination devices may be affixed to a hard frame (valance) or curtain rod for display or may be left unframed where it can function as an illuminated flag, blanket, or wall hanging. U.S. Pat. No. 4,221,255 relates to a decorative panel assembly wherein a valance board receives and maintains a plurality of tracks, the tracks receiving rollers connected to decorative panels. The panels and valance board are provided with edge clamps, acting as moldings, or used for securing decorative coverings thereto. A first source of illumination is provided in the valance board and in front of the panels to cast light upon the same. A second light source is vertically positioned behind the end panels for creating an indirect lighting or ghosting effect. A spring-biased curtain rod holder may be maintained within the valance board and behind the panels, if so desired.

U.S. Pat. No. 5,159,965 is directed to a decorative article for interior decorating purposes such as a cornice, lambrequin or valance for an opening forming a door or window in a wall of a building. The article includes a padded board and at least one opening extending therethrough in the shape of a particular object. The board includes a front layer of fabric overlying a compressible pad on the front face thereof. The edges of the board and the opening are covered with suitable decorative trim. An insert can be provided in the opening to simulate a part of the object represented by the opening. In particular, the opening in the board can represent a bow and the insert can represent a knot in the middle of the bow. Ribbons can also be provided extending downwardly from the lower edge of the insert.

U.S. Pat. No. 4,831,759 refers to a wrap-around valance system physically mounted to the top of a convenience store interior wall system, beneath the ceiling, is formed of end abutting, horizontally aligned, standard size interchangeable illuminated and non-illuminated modules of fabricated sheet metal formed with open front windows slidably mounting respectively, color display photo panels and color graphic decor panels.

The lighting systems disclosed in the prior art mostly relate to static and fixed systems. The lighting is typically designed to originate from only one direction and illuminate at a given intensity. To change the direction, and the type or intensity of the lighting, a different light would generally be required.

### SUMMARY OF THE PRESENT INVENTION

In one aspect of the present invention, a lighting structure comprises: a front chamber assembly having a first side panel and the second side panel, said front chamber assembly comprising a ceiling, a floor, a rear panel and a front panel, said front panel comprising a plurality of apertures; a plurality of lights disposed longitudinally in a row on the ceiling of the front chamber assembly; a first rear extension of the first side panel, said first rear extension of the first side panel being attached to a rear portion of the first side panel; a second rear extension of the second side panel, said second rear extension of the second side panel being attached to a rear portion of the second side panel; a power source and switch adapted to provide electrical power to the lights; and attachment means of said first rear extension of the first side panel to a wall and attachment means of said second rear extension of the second side panel to the wall.

In another aspect of the present invention, a lighting structure comprises: a front chamber assembly having a first side panel and the second side panel, said front chamber assembly comprising a ceiling, a floor, a rear panel and a front panel, said front panel comprising a plurality of apertures; a plurality of lights disposed longitudinally in a row on the ceiling of the front chamber assembly; a first rear extension of the first side panel, said first rear extension of the first side panel being attached to a rear portion of the first side panel; a second rear extension of the second side panel, said second rear extension of the second side panel being attached to a rear portion of the second side panel; a power source and switch adapted to provide electrical power to the lights; attachment means of said first rear extension of the first side panel to a wall and attachment means of said second rear extension of the second side panel to the wall; a top chamber assembly having a first side panel and the second side panel, said top chamber assembly comprising a ceiling, a floor, a rear panel and a front panel, said front panel of the top chamber assembly comprising a plurality of apertures; a plurality of lights disposed longitudinally in a row on the ceiling of the top chamber assembly; said top chamber assembly being attached to a top portion of the first rear extension of the front chamber assembly first side panel and to a top portion of the second rear extension of the front chamber assembly second side panel.

These and other features, aspects and advantages of the present invention will become better understood with reference to the following drawings, description and claims.

### BRIEF DESCRIPTION OF THE DRAWINGS

FIG. 1 is a top perspective view of the lighted decorative framework according to an embodiment of the present invention;

FIG. 2 is a side cross-sectional view of the lighted decorative framework according to an embodiment of the present invention;

FIG. 3 is a top view of the lighted decorative framework fastened to a wall according to an embodiment of the present invention;

FIG. 4 shows an insert panel and replacement panels having apertures in the shape of animal figures according to an embodiment of the present invention;

FIG. 5 shows an insert panel sliding onto the front side of the framework according to an embodiment of the present invention;

FIG. 6 is a front perspective view of the lighted decorative framework according to an embodiment of the present invention;

FIG. 7 is an exploded view of chamber assembly components of the light fixture according to an embodiment of the present invention; and

FIG. 8 presents an embodiment for attaching components of the front chamber assembly and top panel.

### DETAILED DESCRIPTION OF THE INVENTION

The present invention relates to a versatile lighting system configured for providing room lighting that projects into a space and has the flexibility for changing the direction and intensity of the lighting. It is an object of the lighting system of the present invention to provide adjustable lighting to rooms such that the lights dim or turn off at timed intervals or are triggered by motion or sound or the absence or motion or sound.

In one embodiment the lighted decorative framework serves as a window valance and device to hang window treatments as well as a source of lighting for a room. Controlling the lighting functions can be done through wired or wireless systems.

In other configurations, the lighted decorative framework provides a platform for remote sensing of, for example, movement, noise, and/or temperature in a room. This data is used to trigger and control functional responses in the lighted decorative framework such as sound and light, and intensity thereof, or be used to send a message to a receiver, turn on an alarm, or take a picture. The lighted decorative framework also serves as a platform for remote monitoring of rooms such as a baby nursery by concealing a video recording device and transmitter in the lighted decorative framework. The lighted decorative framework may be configured as a wireless device with a unique Internet Protocol (IP) address or configured with other wireless or cellular communication for secure, two-way communication with other electronic devices.

The lighted decorative framework was conceived when the inventors were looking for a night light as well as a better valance system to cover the top of the window treatments for their first child's bedroom. The top of the window is an ideal place for light and also for sensing what a child is doing and responding to it. For example, when our baby started to cry, indirect light from the lighted decorative framework soothed our baby back to sleep. We then realized we could detect a baby's restlessness (motion or sound) and incrementally respond with light or sound to sooth them when they are fussing before they become upset.

In one embodiment in a children's room, this enables children who might be afraid of the dark to go to sleep with all or some of the lights kept on. After a predetermined time lapse, or as the child begins to dose off, all or some of the lights may be manually or automatically dimmed or turned off. Alternatively, if motion or sound from the child is sensed after the child is sleeping the lighted decorative framework can respond with light or sound to sooth the child. The lighted decorative framework can be programmed to change intensities of light or sound corresponding to the amount of motion or noise in the room. Often, a child will go back to sleep after they stir if they see a familiar, comforting light or hear a familiar sound.

It is also the object of the present invention to provide decorative lighting to a room by diffusing light through discrete openings portraying objects and characters such as animals, dinosaurs, fish, trees and legendary characters, symbols. As seasons change and children grow, decorative panels can be easily switched with new designs.

In one embodiment of the present invention, lighting control is done remotely from another room so that the adult does not need to enter the child's room and disturb the sleeping child to dim or turn off the lights.

In another embodiment, the decorative lighted framework of the present invention is adaptable to accommodate window treatments and wall decorations of various designs, widths and thicknesses such as vertical blinds, valances, cornices, horizontal blinds, drapery, quilts and other window or wall hangings. For example, the decorative lighted framework is used to decorate and conceal the top support mechanism of vertical blinds that are often used as window treatments for patio doors and windows. The side panels that support the decorative lighted framework are adjustable to the desired depth to accommodate the size of the window treatment, for example window treatments mounted on the outside of the window frame extend into a room more than those mounted inside and vertical blinds or drapes usually stick out further into a room than horizontal blinds.

Three placement embodiments fall within the scope of the present invention. In one embodiment, the lighted decorative framework is used as a window treatment that may comprise of one or more cornices, one or more valances, blinds, or other curtain and window hangings. In another embodiment, the lighted decorative framework is placed as a lighted shelf unit or on a wall other than a window wall. In yet another embodiment, the lighted decorative framework replaces a ceiling light used for illuminating the room and is adapted to hang from the ceiling.

Three embodiments for powering the light lighted decorative framework fall in the framework of the present invention. In one embodiment, an AC electrical power outlet is placed in the proximity to the lighted framework to minimize the use of wiring. In another version, a solar powered photovoltaic panel is used to charge a battery or capacitor system that would provide power to a direct current (DC) lighting system such as light emitting diodes (LED). In yet another embodiment, a nearby AC outlet is used as the power source and a transformer is used to convert the AC to DC. The DC source is connected to power the lighted decorative framework. If the decorative lighted framework is placed in an area that lacks a nearby outlet, a flat wire can be used for connecting the lighting system to the outlet. The flat wire eliminates loose electrical cords running across walls as it is attached directly to the wall. The flat wire provides an aesthetically pleasing option because the wire is mounted directly to the wall, and can be plastered over or just painted to blend in. Special connectors are used to attach the flat wire to the actual lights. In another scenario, DC wire can be concealed along the window frame with the use of an adhesive strip to attach the wire.

The lighted decorative framework is comprised of two assemblies. The first assembly is an elongated housing that has a length, a width and a height consisting of an optional top panel, a front sub-panel, a left side panel, a right side panel, and an optional bottom panel. For example, the bottom panel would not be used in an installation over a window to allow mounting of window treatments or to show light down over the window, however a bottom panel would be used in a shelf placement of the decorative lighted framework to form a complete enclosure. The first assembly can be a molded or extruded polymer piece, a bent sheet metal piece, or constructed of multiple panels made of wood, metal, plastic, wood laminates or other polymer material. The inside of the top, front sub-panel or side panels can be used to conceal or selectively attach window treatments or decorative wall treatments. The outside of the top panel provides an area to conceal a linear-shaped light assembly used for indirect accent lighting directed upwards towards the ceiling of a structure. The outside of the top panel can also be used to accommodate a light altering insert to change the visible characteristics of the light. The top panel also provides a barrier to keep dirt and dust off of the window treatments or wall treatments. The top panel can also be used to mount an electrical junction box to connect the leads from the lights to the power source. The electrical junction box can be mounted on either side of the top panel depending on where the nearest electrical outlet is. The electrical junction box can also be mounted on the inside of the top panel or the inside of the front sub-panel. The electrical junction box is not necessary on some installations that are directly wired to the outlet. The right and left side panels are decorative on the outside and serve to conceal the window treatment or wall treatment fastening mechanism from a side view. The right and left side panels also receive wall mount hardware to fix the entire decorative lighted framework to the wall. In the case of a ceiling mount for the decorative lighted framework, the top panel would serve as the support for mounting. The front sub-panel of the first housing assembly provides the support for the second housing assembly. The inside of the front sub-panel can be used to attach and conceal an electrical box used to attach light assemblies if they are not directly wired from the power source. The inside of the front sub-panel can also be used to house other electrical devices used for surveillance, wireless communication, sound and sensors. In one embodiment, the inside of the housing formed by the top panel, front sub-panel and side panels can also be used to mount a linear-shaped light assembly used to illuminate downward toward the floor onto the window, window treatment or decorative wall panel. The outside of the front sub-panel also provides an elongated recessed chamber area consisting of a top, bottom and sides used to receive linear-shaped lights used to illuminate the second housing assembly described below. The outside of the front sub-panel is finished with color, texture, sheen and other features to provide the characteristics desired for altering the light that will shine through the second housing assembly described below.

The second assembly consists of a decorative front panel and framework that is mounted to the outside of the front sub-panel of the first housing assembly described above. The assembly consists of a frame and insert panel. The insert panel has decorative apertures cut into it that represent shapes and images of animals, plants, objects, characters, logos and words. The second assembly attached to the first assembly results in a shadow box type enclosure that is illuminated by the lights mounted on the outside of first assembly housing. The light that is entering the room through the apertures is indirect and is conditioned by the finish of the outside of the first assembly housing which reflects the light, the inside finish of the insert panel of the second assembly, the shape of the apertures, and the radius or other finishing characteristics of the actual aperture openings which the light shines through. For example, in some cases, the cut edges of the apertures receive a radius shape on the inside, the outside or both to enhance the visual effect of the lighting. The apertures allow the light diffused from a box-like volume to glow into a room without seeing the lighting directly. The decorative front panel is interchangeable with the framework of the second assembly. This allow the theme to change with the age of the person, the type of room it is used in, the finish desired and other characteristics important to a customer and the setting.

In one embodiment, the elongated recessed area of the first housing assembly consisting of a top, bottom and sides that is used to receive linear-shaped lights used to illuminate the second housing assembly can have slots or apertures cut into the top or bottom of the first housing assembly which would allow light to be directed upwards or downwards, respectively.

In one embodiment, only the front panel has the apertures while the remaining panels are closed. In another embodiment, the front panel as well as the side panels and the bottom panel contain apertures. With this design, light is introduced into the room forward, upward, downward and sideways to maximize the lighting effect. With this design, the enclosure may be divided into compartments each housing a series of lights that transmit light through the apertures of only one panel.

Thus, the compartment that contains the top panel may house multiple colors of linear-shaped light systems, while the compartment that contains the front panel may house a long rope light traversing across the length of the compartment. The lighted decorative framework frame is adapted with grooves or rectangular sections for receiving the decorative panels which will be fastened or slide in and out for easy changeover to allow varying the shapes and designs of the apertures.

The lighting effect can be further enhanced by:

1. Modulating the intensity of the lights
2. The use of filters that cover the apertures for creating a spectrum of diffuse to translucent lights and shades.
3. The use of color lights.
4. The use of electronic controls to change the light color.
5. The finish of the reflective surfaces found in the panels.
6. The characteristics of the cut edge of the apertures.

The light sources providing the lighting are housed in the enclosure contained by the panels. The light sources may be LED, fluorescent or incandescent and may be arranged in a linear fashion such as a ribbon, channel, a tube or a rope. An electronic system provides means to turn the lights on and off and optional dimming of the lights. In one embodiment, the enclosure contains one long light tube spanning the length of the enclosure. In other embodiments, a plurality of lights spanning the full length or partial length and width of the enclosure are used.

The top and side panels of the lighted decorative framework can be utilized as mounting surfaces for window or wall treatment arrangements. The top panel also helps keep window or wall treatments free of dust. Window or wall treatments such as cornices, blinds, shades, valances, and curtains can be top or side mounted directly to the decorative lighted framework that is affixed to the wall, or may be directly mounted to the walls. In this case the decorative lighted framework would cover the mounting hardware such as rods, clips, hooks, brackets, rings and finials. Small rods in conjunction with an angled support mechanism can also be used to allow curtains to hang towards the outside edges of a valance. This would provide a finished look to appeal to some customers and also provide means to hide electrical connection in some installations.

The lighted decorative framework enclosure could be used to house various sensors, controls and their associated electronics. These could include motion sensors, environment control sensors, cameras, surveillance systems, and wireless transmitting devices. The cameras and the surveillance systems could be used, for example, to monitor infants or caregivers. The advantage of mounting sensors in the decorative lighted framework is that the decorative lighted framework is positioned high in the room for unobstructed line of sight and could hide the sensors. The lighted decorative framework can also be used to conceal electrical lines and wires such as a plug-and-play modular low voltage electrical system that comprise of receptacles extending along the axis of the framework.

In one embodiment of the electrical system, a simple terminal block with an in-line on/off switch on the power cord is used. In another embodiment, the electrical system comprises of an electronic circuit board that provides functions including turning off the lights at first daylight, turning off the lights after a pre-set time lapse, turning the lights on if the motion sensor detects movements by a sleeping baby or if the sound sensor detects crying, controls for brightening or dimming the lights to varying degrees, modulation to control power consumption, and power monitoring for solar batteries and their interface to lights and power source. Another option for the sensor based light control devices is to function on the basis of a combination of time interval and motion/noise sensing. Under this scenario, the baby goes to sleep at time X with the lights on and the parent leaves the room. At time X+Y, the controls dim the lights to a fraction of the original brightness depending on the child. At time X+Y+Z, the controls turn the lights off completely. The motion and noise sensors increase light intensity to a preset level if the baby wakes up, cries and/or moves. The electrical system may be designed for programming the various lights to turn on and off separately. For example, the lights that project through the bottom and side panels would be turned off first leaving the lights projecting through the front and top panels on. The lights projecting through the front panel may be turned off next, and finally the lights projecting through the top panel are turned off. In this manner, the lights would be turned off gradually which lessens the chance that the child would be frightened by the sudden change to total dark.

It should be understood that the use of the lighted decorative framework of the present invention is not limited to children's rooms. It can be used in hotel rooms, entertainment halls, dancing halls, restaurants, vacations properties, lodges, hospitals, assisted living facilities and other rooms in a house where they could serve a decorative purpose. For these uses, a panel having apertures representing more appropriate figures or images would be used. The lighted decorative framework of the present invention can also be useful for the elderly to prevent tripping in the bedroom if they get up in during the night to take medicine or go to the bathroom.

Additional features that may be incorporated into the present invention include reflectors and filters. These can assure the light cannot be seen directly through the apertures in the front panel, and also help control the color and dispersion of the light. This could become important with the use of LED lights that are not as soft, subdued and dispersed as incandescent lighting. While some shadowing can be pleasing to a child, excessive shadowing can be frightening. The proper combination of soft lights, reflectors and filters can create a more indirect and mellow effect and prevent excessive shadowing.

In one embodiment, the lighted decorative framework is comprised of a molded or extruded polymer material and the low voltage electrical system is completely integrated into the framework.

In the preferred embodiment of the present invention, the shape of the enclosure box is substantially rectangular. However, other shapes including but not limited to octagonal, square, circular and elliptical, oval, also fall within the scope of the present invention.

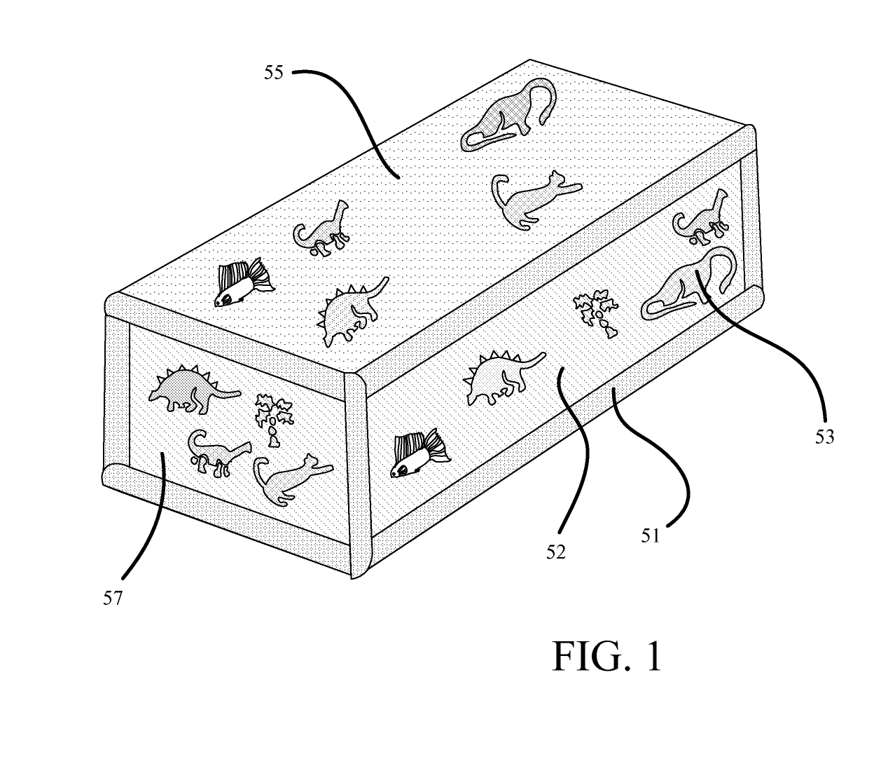

FIG. 1 is a top side perspective view of an embodiment of a lighting fixture showing the front chamber assembly having frame 51, front panel 52 that contains a plurality of apertures 53. Also shown are a top chamber assembly 55 and a first side chamber assembly 57.

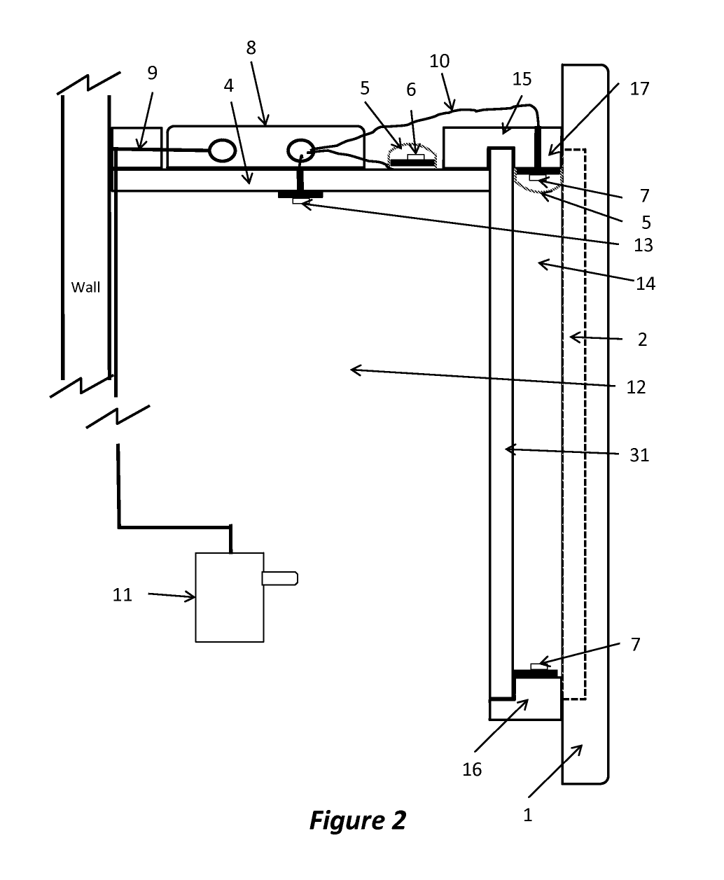

FIG. 2 is a side cross-sectional view of another embodiment of a lighting structure having a front chamber assembly showing the frame 1, the decorative front panel 2, the rear panel 31, ceiling 17, and floor 16. FIG. 2 also features a top panel 4, an optional luminary device, in this case represented as a plurality of linear LED light sources 6 disposed on the top panel 4 that provide indirect accent light upwards, an optional light altering insert 5, an optional electric junction box 8, electric cord 9, electric conduit to the luminary device 10, the power supply that connects to the wall outlet, in this case a converter that switches alternating current to direct current for the solid state lighting 11, the inside of the housing 12 where window treatments or wall treatments, or other electronics can be concealed and optionally fastened to the top panel 4 or the rear panel 31 and an optional luminary device 13, chamber interior 14, a support bar 15 of the chamber ceiling 17 with the top panel 4 that form a box-like structure when the frame 1 and decorative front panel 2 are attached. Linear-shaped lights 7 can be mounted to the ceiling 17 and floor 16 and light 7 can be altered with an optional light altering insert 5.

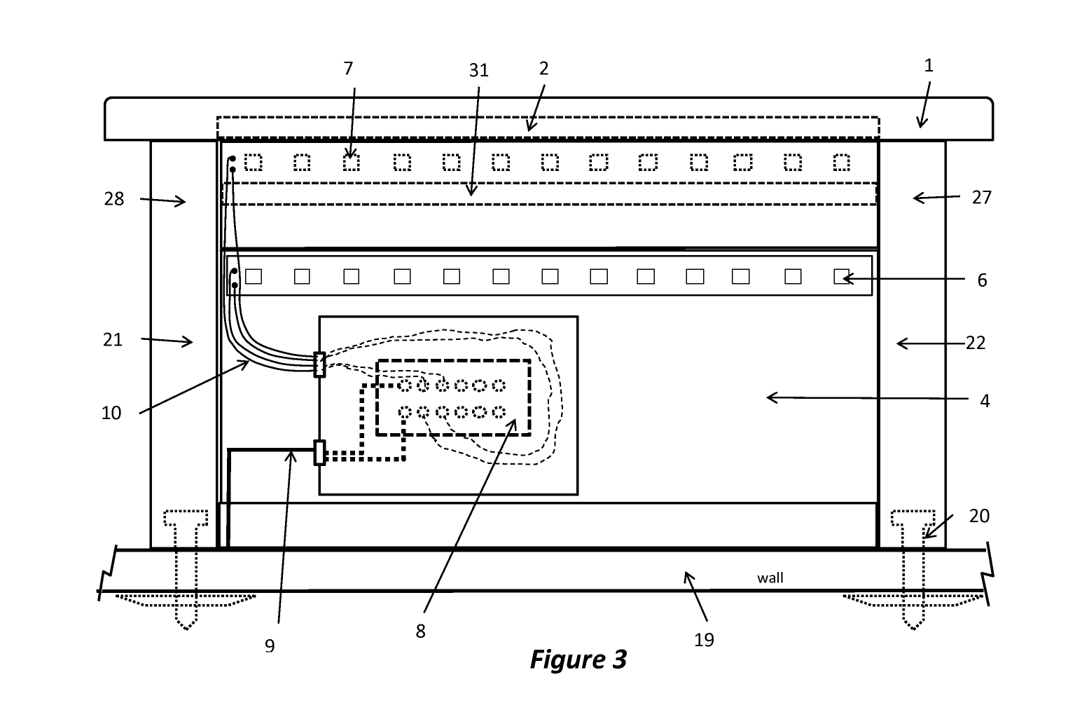

FIG. 3 is a top view of the lighted decorative framework hanging on a wall 19 fastened to the wall with slotted hangers 20 that are connected with the first rear extension side panel 21 and second rear extension side panel 22 to the wall 19. Also shown are the front chamber assembly having frame 1, internal ceiling lights 7, decorative front panel 2, rear panel 31, optional electric junction box 8, electric cord 9, electric conduits to the luminary device 10, top panel 4, lights disposed on the top panel 6, first side panel 27 and second side panel 28.

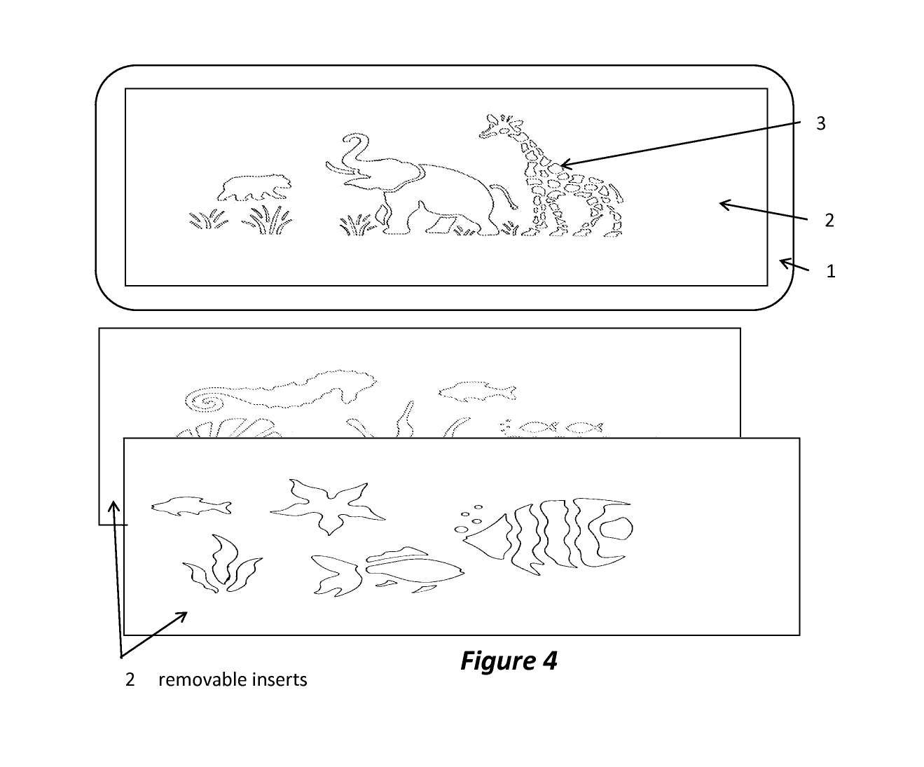

FIG. 4 shows a replacement decorative front panel 2 having a variety of apertures 3. The decorative front panel 2 can be replaced with other decorative replacement panels 2 labelled as removable inserts. The front panel 2 is inserted into a slot built into the backside of frame 1.

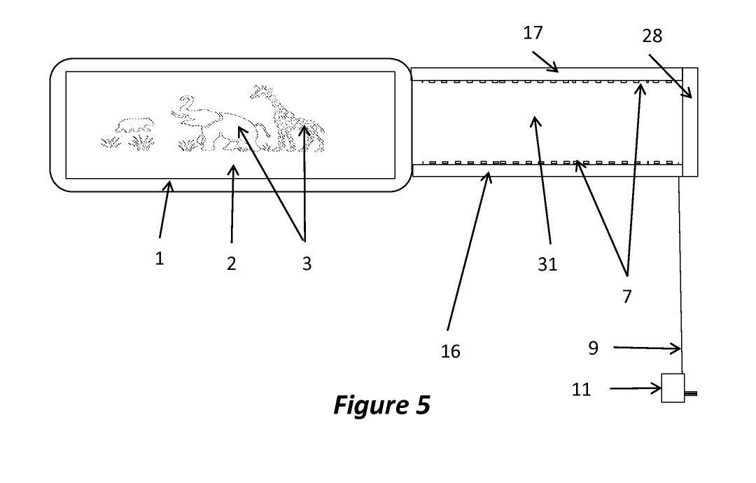

FIG. 5 shows the frame 1 and decorative front panel 2 having a variety of apertures 3 removed from the rear panel 31 which is recessed forming a box like structure by first side panel 28, a ceiling 17 and a floor 16. In the embodiment pictured in FIG. 5, the apertures 3 of the decorative front panel 2 are illuminated by solid state strip light 7 attached to electrical conduit 9 that connects to a power source 11.

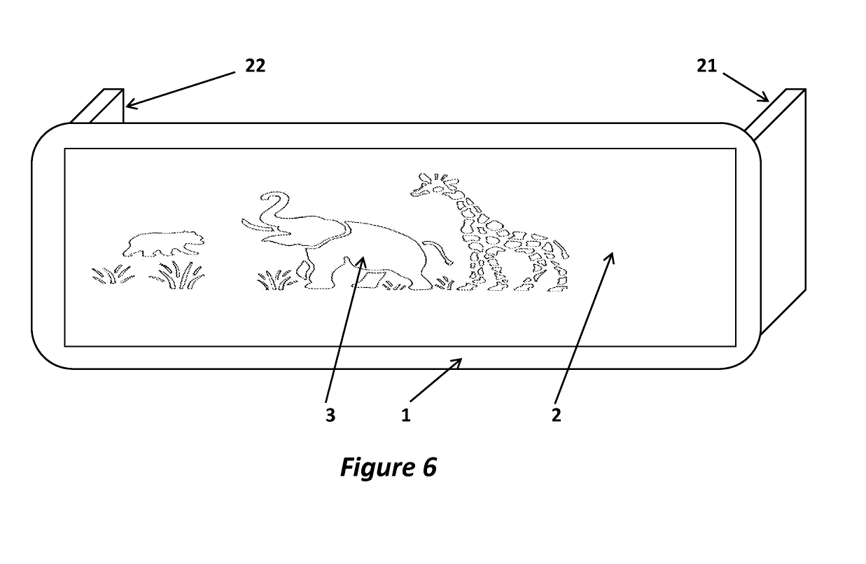

FIG. 6 shows an embodiment of a light fixture front chamber assembly having a frame 1 and replacement decorative front panel 2 having a variety of apertures 3. The fixture has a first rear extension side panel 21 and a second rear extension side panel 22 that are attached to the wall.

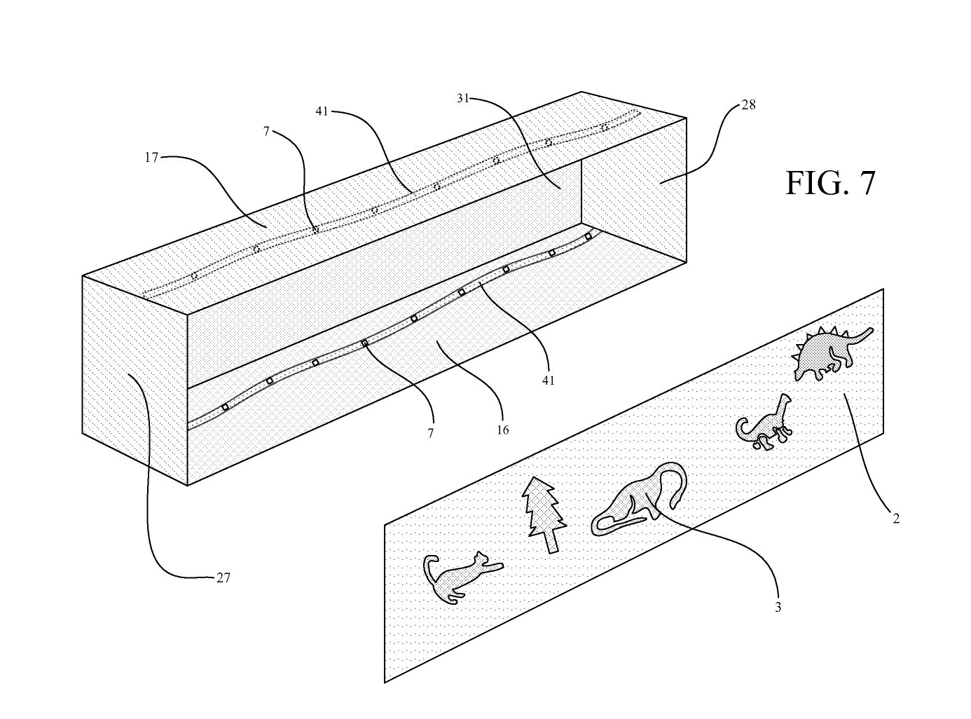

FIG. 7 depicts an exploded view of a chamber assembly showing panel 2 and apertures 3. Also shown are: floor 16, rear panel 31, ceiling 17, first side panel 27, second side panel 28, a solid state strip 41 disposed on the ceiling 17 and floor 16 containing a plurality of solid state lights 7.

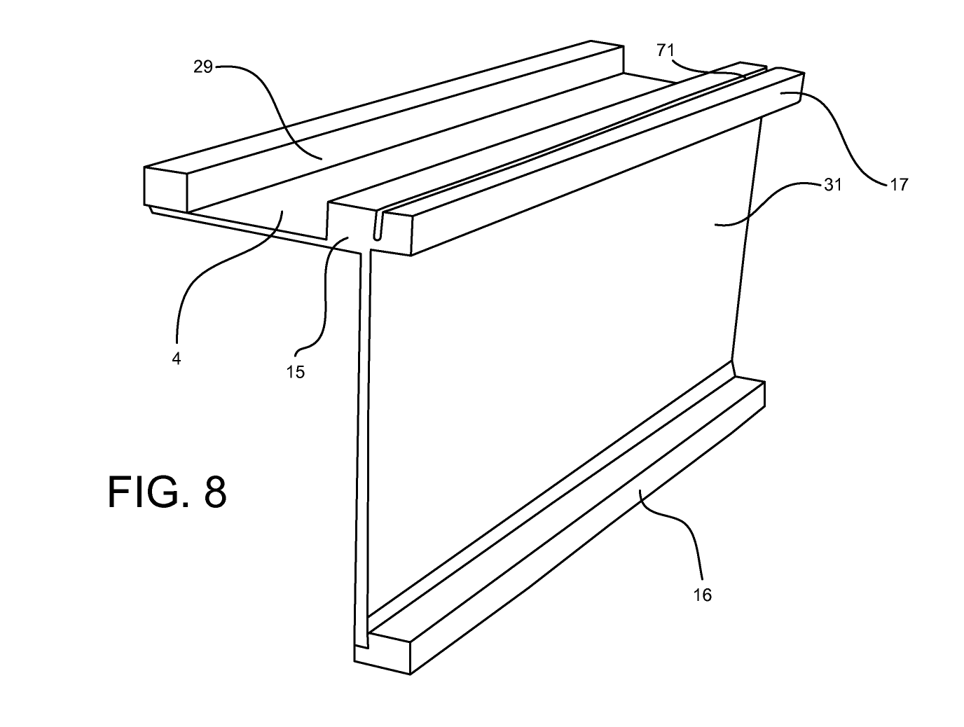

FIG. 8 shows a structure that combines components of the front chamber assembly and top panel 4 indicating floor 16, ceiling 17, rear panel 31, support bars 15 and 29 for supporting a top chamber assembly and slot 71 that may be used to hang the front panel. However, other methods for hanging the panel may be used as well.

We claim:

1. A lighting structure comprising:
a front chamber assembly having a first side panel and a second side panel, said front chamber assembly also comprising a ceiling, a floor, a rear panel and a front panel, said front panel comprising a plurality of apertures;
a plurality of lights disposed longitudinally in a row on the floor of the front chamber assembly;
a first rear extension of the first side panel, said first rear extension of the first side panel being attached to a rear portion of the first side panel;
a second rear extension of the second side panel, said second rear extension of the second side panel being attached to a rear portion of the second side panel;
a power source and switch adapted to provide electrical power to the lights; and
attachment means of said first rear extension of the first side panel to a wall and attachment means of said second rear extension of the second side panel to the wall.

2. The lighting structure of claim 1 further comprising a plurality of lights disposed longitudinally in a row on the ceiling of the front chamber assembly.

3. The lighting structure of claim 1 further comprising a top panel having a first side and a second side, said first side of the top panel being attached to a top portion of the first rear extension of the first side panel, said second side of the top panel being attached to a top portion of the second rear extension of the second side panel.

4. The lighting structure of claim 3 further comprising a plurality of lights disposed in a row longitudinally on an outer portion of the top panel.

5. The lighting structure of claim 1, wherein the front panel comprises a frame and an insert panel, said insert panel being adapted for insertion into and out of the frame, said apertures being disposed within the insert panel, said frame being adapted for attaching onto the a front portion of the front chamber assembly.

6. The lighting structure of claim 1, wherein the lights comprise solid state strip lights.

7. The lighting structure of claim 1, wherein the apertures have decorative shapes.

8. A lighting structure comprising:
a front chamber assembly having a first side panel and a second side panel, said front chamber assembly comprising a ceiling, a floor, a rear panel and a front panel, said front panel comprising a plurality of apertures;
a plurality of lights disposed longitudinally in a row on the floor of the front chamber assembly;
a first rear extension of the first side panel, said first rear extension of the first side panel being attached to a rear portion of the first side panel;
a second rear extension of the second side panel, said second rear extension of the second side panel being attached to a rear portion of the second side panel;
a power source and switch adapted to provide electrical power to the lights;
attachment means of said first rear extension of the first side panel to a wall and attachment means of said second rear extension of the second side panel to the wall;
a top chamber assembly having a first side panel and the second side panel, said top chamber assembly comprising a ceiling, a floor, a rear panel and a front panel, said front panel of the top chamber assembly comprising a plurality of apertures;
a plurality of lights disposed longitudinally in a row on the ceiling of the top chamber assembly;
said top chamber assembly being attached to a top portion of the first rear extension of the front chamber assembly first side panel and to a top portion of the second rear extension of the front chamber assembly second side panel.

9. The lighting structure of claim 8 further comprising:
a first side chamber assembly having a first side panel and the second side panel, said first side chamber assembly comprising a ceiling, a floor, a rear panel and a front panel, said front panel of the first side chamber assembly comprising a plurality of apertures;
a plurality of lights disposed longitudinally in a row on the floor of the first side chamber assembly;
said first side chamber assembly being attached to a side portion of the first rear extension of the front chamber assembly first side panel.

10. The lighting structure of claim 9 further comprising:
a second side chamber assembly having a first side panel and the second side panel, said second side chamber assembly comprising a ceiling, a floor, a rear panel and a front panel, said front panel of the second side chamber assembly comprising a plurality of apertures;
a plurality of lights disposed longitudinally in a row on the floor of the second side chamber assembly;
said second side chamber assembly being attached to a side portion of the second rear extension of the front chamber assembly second side panel.

11. The lighting structure of claim 10 further comprising:
a bottom chamber assembly having a first side panel and the second side panel, said bottom chamber assembly comprising a ceiling, a floor, a rear panel and a front panel, said front panel of the bottom chamber assembly comprising a plurality of apertures;
a plurality of lights disposed longitudinally in a row on the floor of the bottom chamber assembly;
said bottom chamber assembly being attached to a bottom portion of the first rear extension of the front chamber assembly first side panel and to a bottom portion of the second rear extension of the front chamber assembly second side panel.

12. The lighting structure of claim 8, wherein the front panel of the top chamber assembly comprises a frame and an insert panel, said insert panel of the top chamber assembly being adapted for insertion into and out of the frame of the top chamber assembly, said apertures being disposed within the insert panel of the top chamber assembly, said frame of the top chamber assembly being adapted for attaching onto a front portion of the top chamber assembly.

13. The lighting structure of claim 9, wherein the front panel of the first side chamber assembly comprises a frame and an insert panel, said insert panel of the first side chamber assembly being adapted for insertion into and out of the frame of the first side chamber assembly, said apertures being disposed within the insert panel of the first side chamber assembly, said frame of the first side chamber assembly being adapted for attaching onto a front portion of the first side chamber assembly.

14. The lighting structure of claim 10, wherein the front panel of the second side chamber assembly comprises a frame and an insert panel, said insert panel of the second side chamber assembly being adapted for insertion into and out of the frame of the second side chamber assembly, said apertures being disposed within the insert panel of the second side chamber, said frame of the second side chamber assembly being adapted for attaching onto a front portion of the second side chamber assembly.

15. The lighting structure of claim 11, wherein the front panel of the bottom chamber assembly comprises a frame and an insert panel, said insert panel of the bottom chamber assembly being adapted for insertion into and out of the frame of the bottom chamber assembly, said apertures being disposed within the insert panel of the bottom chamber assembly, said frame of the bottom chamber assembly being adapted for attaching onto a front portion of the bottom chamber assembly.

16. The lighting structure of claim 11, wherein the lights comprise solid state strip lights.

17. The lighting structure of claim 11, wherein the apertures have decorative shapes.

18. The lighting structure of claim 8 further comprising a top panel having a first side and a second side, said first side of the top panel being attached to a top portion of the first rear extension of the first side panel, said second side of the top panel being attached to a top portion of the second rear extension of the second side panel.

19. The top panel of claim 18 further comprising a plurality of lights disposed in a row longitudinally on an outer portion of the top panel, said top panel being disposed below the top chamber assembly.

20. The lighting structure of claim 8 further comprising a plurality of lights disposed longitudinally in a row on the ceiling of the front chamber assembly.
